(19) United States
(12) Patent Application Publication
(10) Pub. No.: US 2008/0245350 A1
(43) Pub. Date: Oct. 9, 2008

(54) SYSTEM AND METHOD FOR USING VEGETABLE OIL AS FUEL FOR DIESEL ENGINES

(76) Inventor: John TRISKA, Bradenton, FL (US)

Correspondence Address: STITES & HARBISON PLLC, 1199 NORTH FAIRFAX STREET, SUITE 900, ALEXANDRIA, VA, 22314, US

(21) Appl. No.: 12/098,042

(22) Filed: Apr. 4, 2008

Related U.S. Application Data
(60) Provisional application No. 60/910,617, filed on Apr. 6, 2007.

(51) Int. Cl. F02M 1/16

(52) U.S. Cl. 123/575; 123/576; 701/103

(57) ABSTRACT

A system and method for using vegetable oil as fuel for a diesel engine includes: a diesel fuel tank; a vegetable oil fuel tank, a supply fuel valve for switching a supply fuel output port between a diesel fuel input port and a vegetable oil fuel input port; an overflow fuel valve for switching an overflow fuel input port between a vegetable oil fuel output port and a diesel fuel output port; a fuel selector switch; and an electronic block controller. The electronic block controller is for, in response to a user changing the fuel selector switch from diesel fuel to vegetable oil fuel, waiting a predetermined amount of time to allow the vegetable oil fuel to flush the diesel fuel to the overflow fuel valve, and then setting the overflow fuel valve to direct overflow vegetable oil fuel to the vegetable oil fuel tank. Cross-contamination of the fuel tanks is avoided.

### CROSS-REFERENCE TO RELATED APPLICATIONS

This application claims the benefit of U.S. Provisional Patent Application No. 60/910,617, filed Apr. 6, 2007, the entire disclosure of which is hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates to a system and method for using vegetable oil as fuel for diesel engines.

2. Description of Prior Art

A known problem with the use of vegetable oil as fuel for diesel engines is that the viscosity of vegetable oil is thicker that the viscosity of diesel fuel at ambient temperatures. One possible solution to this problem is heating, or pre-heating, the vegetable oil to reduce its viscosity.

However, a problem with pre-heating vegetable oil for use as fuel for diesel engines has been in getting the vegetable oil to an elevated temperature for use with the engine. This issue is particularly problematic when performing a cold start on the diesel engine. Once a diesel engine is running, a certain amount of waste heat generated by the engine can be used, in theory, to heat the vegetable oil.

One proposed solution to the issue of getting the vegetable oil to an elevated temperature, and the associated cold start problem, is to use a two-tank system where one tank contains vegetable oil fuel, and the other tank contains diesel fuel. The engine is cold-started using the diesel fuel. Once the engine is running and generating heat that can be used to heat the vegetable oil fuel, the fuel source for the engine can be switched to the vegetable oil fuel.

However, a problem with duel tank systems is cross-contamination of the fuel tanks. Overflow fuel from the high pressure injection pump of the diesel engine must be addressed. In systems that direct the overflow fuel to whatever tank is being used, when the fuel source is switched a certain amount of the other fuel that is already in the piping will be directed to the wrong tank, causing cross-contamination.

Thus, there is a need for a system and method for using vegetable oil as a fuel for a diesel engine that allows: 1) a two-tank system where one tank contains the vegetable oil fuel, and the other tank contains diesel fuel; 2) starting the engine using the diesel fuel; 3) switching to the vegetable oil fuel without cross-contamination of the fuel tanks; and 4) switching back to the diesel fuel without cross-contamination of the fuel tanks.

### BRIEF SUMMARY OF THE INVENTION

The present invention meets these needs, and others.

As used herein, the phrase “vegetable oil” broadly refers to any of a number of oils or fats suitable for use as a fuel, including, but not limited to: Babassu Oil, Castor Oil, Coconut Oil, Corn Oil, Cottonseed Oil, Crambe Oil, Linseed Oil, Olive Oil, Palm Oil, Peanut Oil, Rapeseed Oil, Safflower Oil, High-oleic Safflower Oil, Sesame Oil, Soybean Oil, Sunflower Oil, Tallow Oil, Diesel No. 2, and Waste Vegetable Oil.

According to one aspect of the invention, a system for using vegetable oil as fuel for a diesel engine includes: a diesel engine; a high pressure injection pump having a fuel input port for receiving fuel, a high pressure fuel output port for supplying high pressure fuel to the diesel engine (actually, the injectors of the diesel engine), and an overflow fuel output port for outputting overflow fuel; a diesel fuel tank for supplying diesel fuel, and receiving overflow diesel fuel from the high pressure injection pump; and a vegetable oil tank for supplying vegetable oil fuel, and receiving overflow vegetable oil fuel from the high pressure injection pump. The system also includes: a supply fuel valve having a diesel fuel input port for receiving diesel fuel from the diesel fuel tank, a vegetable oil fuel input port for receiving vegetable oil fuel from the vegetable oil fuel tank, a supply fuel output port, the supply fuel valve for switching fluid communication of the supply fuel output port between the diesel fuel input port and the vegetable oil fuel input port; an overflow fuel valve having an overflow fuel input port for receiving overflow fuel from the high pressure injection pump, a vegetable oil fuel output port for sending overflow vegetable oil fuel to the vegetable oil fuel tank, and a diesel fuel output port for sending overflow diesel fuel to the diesel fuel tank, the overflow fuel valve for switching fluid communication of the overflow fuel input port between the vegetable oil fuel output port and the diesel fuel output port; a fuel selector switch; and an electronic block controller. The electronic block controller is for, in response to a user changing the fuel selector switch from diesel fuel to vegetable oil fuel after starting the diesel engine, sending a control signal to set the supply fuel valve to direct vegetable oil fuel to the supply fuel output port, and waiting a predetermined amount of time to allow the vegetable oil fuel to flush the diesel fuel to the overflow fuel valve and then sending a control signal to set the overflow fuel valve to direct overflow vegetable oil fuel to the vegetable oil fuel output port.

In one implementation, the electronic block controller is further for, in response to a user changing the fuel selector switch from vegetable oil fuel to diesel fuel prior to shutting the diesel engine off, sending a control signal to set the supply fuel valve to direct diesel fuel to the supply fuel output port, and waiting a predetermined amount of time to allow the diesel fuel to flush the vegetable oil fuel to the overflow fuel valve and then sending a control signal to set the overflow fuel valve to direct overflow diesel fuel to the diesel fuel output port.

In another implementation, the system further includes a diesel fuel pump for pumping diesel fuel from the diesel fuel tank to the supply fuel valve, and a vegetable oil fuel pump for pumping vegetable oil fuel from the vegetable oil fuel tank to the supply fuel valve. The electronic block controller is further for, in response to a user changing the fuel selector switch from diesel fuel to vegetable oil fuel after starting the diesel engine, sending control signals to turn the vegetable oil fuel pump on and the diesel fuel pump off.

According to yet another important implementation, the electronic block controller is further for, in response to a user changing the fuel selector switch from vegetable oil fuel to diesel fuel prior to shutting the diesel engine off, sending control signals to turn the diesel fuel pump on and the vegetable oil fuel pump off.

The system may further include indicator lights in communication with the electronic block controller. In one case, the electronic block controller is further for, in response to a user setting the fuel selector switch to vegetable oil fuel operation, sending a signal to display an indication on the indicator lights that the fuel selector switch is set to vegetable oil fuel operation. In another case, the electronic block controller is further for, in response to a user setting the fuel selector switch to diesel fuel operation, sending a signal to display an indication on the indicator lights that the fuel selector switch is set to diesel fuel operation.

According to another aspect of the invention, a method for using vegetable oil as fuel for a diesel engine, includes, in response to a user setting a fuel selector switch to diesel fuel prior to starting a diesel engine: positioning a supply fuel valve to direct diesel fuel from a diesel fuel input port to a supply fuel output port which is in fluid communication with a fuel input port of a high pressure injection pump, the diesel fuel being received from a diesel fuel tank; and positioning an overflow fuel valve to direct overflow diesel fuel received from the high pressure injection pump to a diesel fuel output port in fluid communication with an overflow diesel fuel input port of the diesel fuel tank. The method further includes: starting said diesel engine; and, in response to the user changing the fuel selector switch from diesel fuel to vegetable oil fuel after starting the diesel engine: positioning the supply fuel valve to direct vegetable oil fuel from a vegetable oil fuel input port to the supply fuel output port, the vegetable oil fuel being received from a vegetable oil fuel tank; waiting a predetermined time to allow the vegetable oil fuel to flush the diesel fuel to the overflow fuel valve, and then positioning the overflow fuel valve to direct overflow vegetable oil fuel received from the high pressure injection pump to a vegetable oil fuel output port in fluid communication with a overflow vegetable oil fuel input port of the vegetable oil fuel tank. In response to the user changing the fuel selector switch from vegetable oil fuel to diesel fuel prior to shutting the diesel engine off, the method includes: positioning the supply fuel valve to direct diesel fuel from the diesel fuel input port to the supply fuel output port; and waiting a predetermined time to allow the diesel fuel to flush the vegetable oil fuel to the overflow fuel valve, and then positioning the overflow fuel valve to direct overflow diesel fuel received from the high pressure injection pump to the diesel fuel output port and the overflow diesel fuel input port of the diesel fuel tank.

In accordance with an important implementation, the method further includes: turning on a diesel fuel pump for pumping diesel fuel from the diesel fuel tank to the diesel fuel input port of the supply fuel valve in response to the user setting the fuel selector switch to diesel fuel prior to starting the diesel engine; turning off the diesel fuel pump and turning on the vegetable oil fuel pump for pumping vegetable oil fuel from the vegetable oil fuel tank to the vegetable oil fuel input port of the supply fuel valve in response to the user changing the fuel selector switch from diesel fuel to vegetable oil fuel after starting the diesel engine; and turning off the vegetable oil fuel pump and turning on the diesel fuel pump in response to the user changing the fuel selector switch from vegetable oil fuel to diesel fuel prior to shutting the diesel engine off.

In accordance with another important implementation, the method further includes: displaying an indication on indicator lights that the fuel selector switch is set to diesel fuel operation in response to the user setting the fuel selector switch to diesel fuel prior to starting the diesel engine; displaying an indication on indicator lights that the fuel selector switch is set to vegetable oil fuel operation in response to the user changing the fuel selector switch from diesel fuel to vegetable oil fuel after starting the diesel engine; and displaying an indication on indicator lights that the fuel selector switch is set to diesel fuel operation in response to the user changing the fuel selector switch from vegetable oil fuel to diesel fuel prior to shutting the diesel engine off.

Other features and advantages of the invention with be set forth in, or apparent from, the detailed description of exemplary embodiments of the invention found below.

### BRIEF DESCRIPTION OF THE SEVERAL VIEWS OF THE DRAWINGS

FIG. 1 is a functional block diagram of a system for using vegetable oil as fuel for diesel engines according to an exemplary embodiment of the invention.

FIG. 2 is a schematic diagram of a supply fuel valve of the system of FIG. 1.

FIG. 3 is a schematic diagram of a overflow fuel valve of the system of FIG. 1.

### DETAILED DESCRIPTION OF EXEMPLARY EMBODIMENTS OF THE INVENTION

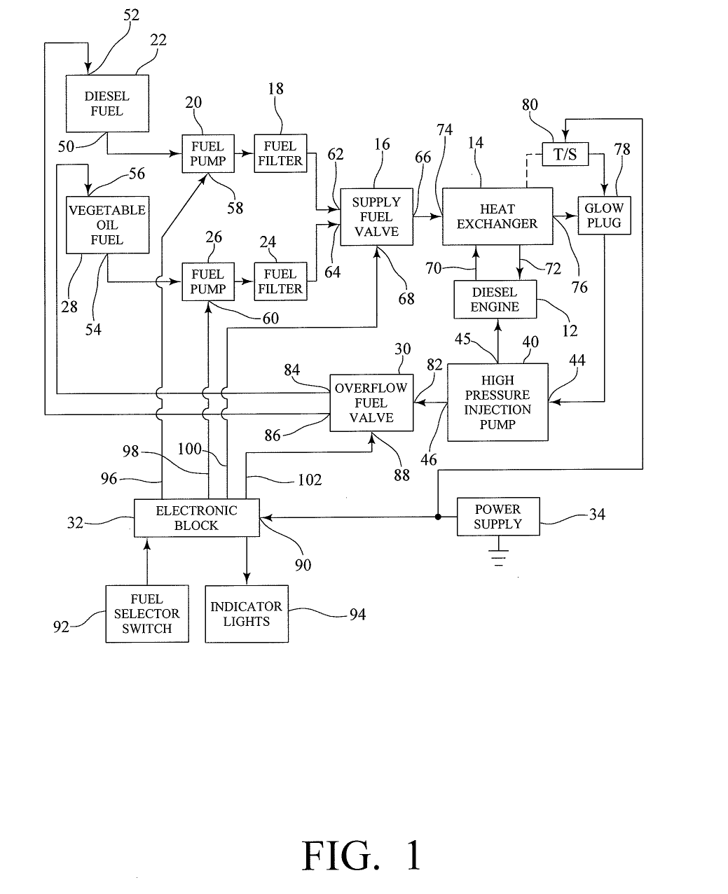

Referring to FIG. 1, an exemplary system 10 for using vegetable oil as fuel for a diesel engine comprises: a diesel engine 12; a heat exchanger 14; supply fuel valve 16; a diesel fuel filter 18; a diesel fuel pump 20; a diesel fuel tank 22; a vegetable oil fuel filter 24; a vegetable oil fuel pump 26; a vegetable oil fuel tank 28; an overflow fuel valve 30, an electronic block controller 32; and a power supply 34.

A high pressure injection pump 40 supplies high pressure fuel to the diesel engine 12 (actually, the injectors of the diesel engine 12). The high pressure injection pump 40 has a fuel input port 44, a high pressure fuel output port 45, and an overflow fuel output port 46. The high pressure pump 40 receives fuel at the fuel input port 44, supplies pressurized fuel to the diesel engine 12 at the high pressure fuel output port 45, and outputs overflow fuel at the overflow fuel output port 46. The diesel engine 12 converts the fuel to energy in a combustion process.

As discussed above, the diesel engine 12 can utilize either diesel fuel or vegetable oil fuel as a fuel source, although it is preferred to reduce the viscosity of vegetable oil fuel by pre-heating the vegetable oil fuel. This can be accomplished in a two tank system by starting the diesel engine 12 using diesel fuel, and then switching to vegetable oil fuel once the engine is started. It is necessary to switch back to diesel fuel and flush the diesel engine of vegetable oil before shutting then engine off, so that the diesel fuel can be used to start the diesel engine 12 the next time the diesel engine 12 is started. Advantageously, the exemplary system 10 described herein allows for such operation and prevents cross-contamination of the diesel fuel tank 22 and the vegetable oil fuel tank 28 by delaying the switching of the overflow fuel valve 30 an amount of time adequate to allow the pre-switch fuel type to flush through the supply fuel valve 16, the heat exchanger 14, the high pressure injection pump 40 (and the diesel engine 12), and the overflow fuel valve 30, as described in more detail below.

The diesel fuel tank 22 is for holding diesel fuel. The diesel fuel tank 22 has a diesel fuel output port 50 and a overflow diesel fuel input port 52. Not shown is a diesel fuel “fill port” for adding diesel fuel to the diesel fuel tank 22.

The vegetable oil fuel tank 28 is for holding vegetable oil fuel. The vegetable oil fuel tank 28 has a vegetable oil fuel output port 54 and a overflow vegetable oil fuel input port 56. Not shown is a vegetable oil fuel “fill port” for adding vegetable oil fuel to the vegetable oil fuel tank 28.

The diesel fuel pump 20 is for receiving diesel fuel from the diesel fuel output port 50 of the diesel fuel tank 22, and pumping the diesel fuel through the diesel fuel filter 18, the supply fuel valve 16, the heat exchanger 14 and to the high pressure injection pump fuel input port 44. The diesel fuel pump 20 has a diesel fuel pump control input 58 that receives a control signal from the electronic block 32, as described below.

The vegetable oil fuel pump 26 is for receiving vegetable oil fuel from the vegetable oil fuel output port 54 of the vegetable oil fuel tank 28, and pumping the vegetable oil fuel through the vegetable oil fuel filter 24, the supply fuel valve 16, the heat exchanger 14 and to the high pressure injection pump fuel input port 44. The vegetable oil fuel pump 26 has a vegetable oil fuel pump control input 60 that receives a control signal from the electronic block 32, as described below.

FIG. 2 shows the supply fuel valve 16 which has a diesel fuel input port 62, a vegetable oil fuel input port 64, and a supply fuel output port 66. The supply fuel valve 16 is for switching fluid communication of the supply fuel output port 66 between the diesel fuel input port 62 and the vegetable oil fuel input port 64. A supply fuel valve control input 68 controls the position of the valve, preferable through a solenoid switch or the like. The supply fuel valve control input 68 receives a control signal from the electronic block 32, as described below.

Returning now to FIG. 1, heated coolant from the diesel engine 12 is circulated through the heat exchanger 14 through engine coolant lines 70, 72. Supply fuel is also circulated through the heat exchanger, being received at a heat exchanger fuel input port 74, and discharged at a heat exchanger fuel output port 76. The heat exchanger 14 transfers heat from the engine coolant to the supply fuel.

The supply fuel then flows from the heat exchanger fuel output port 76 to the high pressure injection pump fuel input port 44.

In the exemplary system 10, a glow plug 78 heats the supply fuel to a temperature that is usable by the diesel engine 12 before the diesel engine 12 reaches its “running temperature.” A temperature sensor 80, such as a thermocouple, senses the temperature of the supply fuel, and supplies power to the glow plug 78 from the power supply 34 when the temperature is below a threshold value. The power supply 34 is preferably a power generation/storage system powered by the diesel engine 12.

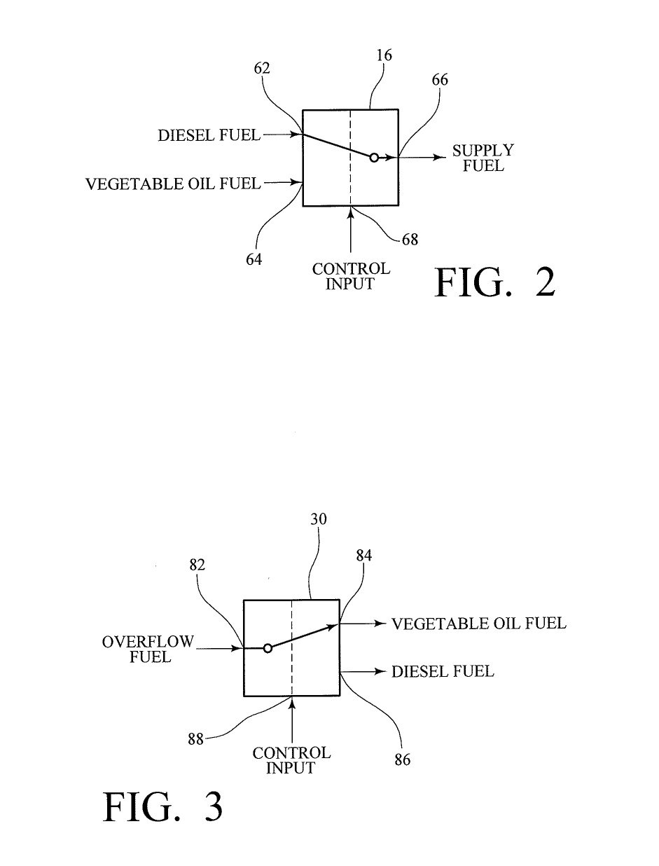

FIG. 3 shows the overflow fuel valve 30 which has a overflow fuel input port 82, a vegetable oil fuel output port 84, a diesel fuel output port 86, and a overflow fuel valve control input 88. The overflow fuel valve 30 is for switching fluid communication of the overflow fuel input port 82 between the vegetable oil fuel output port 84 and the diesel fuel output port 86. The overflow fuel valve control input 88 controls the position of the valve, preferable through a solenoid switch or the like. The overflow fuel valve control input 88 receives a control signal from the electronic block 32, as described below.

Returning again to FIG. 1, the vegetable oil fuel output port 84 is in fluid communication with the overflow vegetable oil fuel input port 56 of the vegetable oil fuel tank 28. The diesel fuel output port 86 is in fluid communication with the overflow diesel fuel input port 52 of the diesel fuel tank 22.

The electronic block controller 32 has a power input 90, a fuel selector switch 92, indicator lights 94, a diesel fuel pump control output 96, a vegetable oil fuel pump control output 98, a supply fuel valve control output 100, and an overflow fuel valve control output 102. The power input 90 is in communication with the power supply 34. The diesel fuel pump control output 96 is in communication with the diesel fuel pump control input 58. The vegetable oil fuel pump control output 98 is in communication with the vegetable oil fuel pump control input 60. The supply fuel valve control output 100 is in communication with the supply fuel valve control input 68. The overflow fuel valve control output 102 is in communication with the overflow valve control input 88.

In use, the electronic block controller 32 reads or receives an input from the fuel selector switch 92, which is set by a user to select the fuel type to be used by the diesel engine 12, i.e., diesel fuel or vegetable oil fuel. In practice, the diesel engine 12 is started using diesel fuel. Thus, the user sets the fuel selector switch 92 to “diesel fuel” and the electronic block controller 32 reads or receives the “diesel fuel” selection from the fuel selector switch 92.

In response, the electronic block controller 32:
sends, via the diesel fuel pump control output 96, a control signal to the diesel fuel pump control input 58 to turn the diesel fuel pump 20 on;
sends, via the vegetable oil fuel pump control output 98, a control signal to the vegetable oil fuel pump control input 60 to turn the vegetable oil fuel pump 26 off;
sends, via the supply fuel valve control output 100, a control signal to the supply fuel valve control input 68 to set the supply fuel valve 16 such that the diesel fuel input port 62 is in fluid communication with the supply fuel output port 66;
sends, via the overflow fuel valve control output 102, a control signal to the overflow fuel valve control input 88 to set the overflow fuel valve 30 such that the overflow fuel input port 82 is in fluid communication with the diesel fuel output port 86; and
sends a signal to display an indication on the indicator lights 94 that the exemplary system 10 is set to “diesel fuel” operation.

Advantageously, since it is contemplated that the exemplary system 10 will operate primarily using vegetable oil fuel, if the supply fuel valve 16 and the overflow fuel valve 30 are operated by solenoid positioners, the “diesel fuel” operation position of the valves 16, 30 may be configured as the “energized” position of the solenoid positioner, and the “vegetable oil fuel” operation position as the “de-energized” position so that the solenoid positioners will be in the “de-energized” position during primary operation of the exemplary system 10.

After the diesel engine 12 is started, the user sets the fuel selector switch 92 to “vegetable oil fuel” and the electronic block controller 32 reads or receives the “vegetable oil fuel” selection from the fuel selector switch 92.

In response, the electronic block controller 32:
sends, via the diesel fuel pump control output 96, a control signal to the diesel fuel pump control input 58 to turn the diesel fuel pump 20 off;
sends, via the vegetable oil fuel pump control output 98, a control signal to the vegetable oil fuel pump control input 60 to turn the vegetable oil fuel pump 26 on;
sends, via the supply fuel valve control output 100, a control signal to the supply fuel valve control input 68 to set the supply fuel valve 16 such that the vegetable oil fuel input port 64 is in fluid communication with the supply fuel output port 66;
waits a predetermined amount of time to allow the vegetable oil fuel to flush the diesel fuel through to the overflow fuel valve 30 and, then, sends, via the overflow fuel valve control output 102, a control signal to the overflow fuel valve control input 88 to set the overflow fuel valve 30 such that the overflow fuel input port 82 is in fluid communication with the vegetable oil fuel output port 84; and
sends a signal to display an indication on the indicator lights 94 that the exemplary system 10 is set to “vegetable oil fuel” operation.

The predetermined amount time that the electronic block controller 32 waits to send the control signal to set the overflow fuel valve 30 to the vegetable oil fuel position depends on the length of the fuel lines and other factors that will vary from vehicle to vehicle. The predetermined time is determined and set at the time of installation of the exemplary system 10 based on these factors. The electronic block controller 32 may be implemented as a state machine using a microcontroller or other operable combination of components, such as time delay relays, within the spirit and scope of the invention as described and claimed herein.

Before shutting the engine off, the user sets the fuel selector switch 92 to “diesel fuel” so that diesel fuel is present in the high pressure injection pump 40 for the next time the diesel engine 12 is started. The electronic block controller 32 reads or receives the “diesel fuel” selection from the fuel selector switch 92.

In response, the electronic block controller 32:
sends, via the diesel fuel pump control output 96, a control signal to the diesel fuel pump control input 58 to turn the diesel fuel pump 20 on;
sends, via the vegetable oil fuel pump control output 98, a control signal to the vegetable oil fuel pump control input 60 to turn the vegetable oil fuel pump 26 off;
sends, via the supply fuel valve control output 100, a control signal to the supply fuel valve control input 68 to set the supply fuel valve 16 such that the diesel fuel input port 62 is in fluid communication with the supply fuel output port 66;
waits a predetermined amount of time to allow the diesel fuel to flush the vegetable oil fuel through to the overflow fuel valve 30 and, then, sends, via the overflow fuel valve control output 102, a control signal to the overflow fuel valve control input 88 to set the overflow fuel valve 30 such that the overflow fuel input port 82 is in fluid communication with the diesel fuel output port 86; and
sends a signal to display an indication on the indicator lights 94 that the exemplary system 10 is set to “diesel fuel” operation.

One of ordinary skill in the art will recognize that additional steps and configurations are possible without departing from the teachings of the invention. This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

What is claimed is:

1. A system for using vegetable oil as fuel for a diesel engine comprising:
a diesel engine;
a high pressure injection pump having a fuel input port for receiving fuel, a high pressure fuel output port for supplying high pressure fuel to the diesel engine, and an overflow fuel output port for outputting overflow fuel;
a diesel fuel tank for supplying diesel fuel, and receiving overflow diesel fuel from the high pressure injection pump;
a vegetable oil tank for supplying vegetable oil fuel, and receiving overflow vegetable oil fuel from the high pressure injection pump;
a supply fuel valve having a diesel fuel input port for receiving diesel fuel from the diesel fuel tank, a vegetable oil fuel input port for receiving vegetable oil fuel from the vegetable oil fuel tank, a supply fuel output port, the supply fuel valve for switching fluid communication of the supply fuel output port between the diesel fuel input port and the vegetable oil fuel input port;
an overflow fuel valve having an overflow fuel input port for receiving overflow fuel from the high pressure injection pump, a vegetable oil fuel output port for sending overflow vegetable oil fuel to the vegetable oil fuel tank, and a diesel fuel output port for sending overflow diesel fuel to the diesel fuel tank, the overflow fuel valve for switching fluid communication of the overflow fuel input port between the vegetable oil fuel output port and the diesel fuel output port;
a fuel selector switch; and
an electronic block controller for, in response to a user changing the fuel selector switch from diesel fuel to vegetable oil fuel after starting the diesel engine, sending a control signal to set the supply fuel valve to direct vegetable oil fuel to the supply fuel output port, and waiting a predetermined amount of time to allow the vegetable oil fuel to flush the diesel fuel to the overflow fuel valve and then sending a control signal to set the overflow fuel valve to direct overflow vegetable oil fuel to the vegetable oil fuel output port.

2. The system of claim 1, wherein the electronic block controller is further for, in response to a user changing the fuel selector switch from vegetable oil fuel to diesel fuel prior to shutting the diesel engine off, sending a control signal to set the supply fuel valve to direct diesel fuel to the supply fuel output port, and waiting a predetermined amount of time to allow the diesel fuel to flush the vegetable oil fuel to the overflow fuel valve and then sending a control signal to set the overflow fuel valve to direct overflow diesel fuel to the diesel fuel output port.

3. The system of claim 2, further comprising a diesel fuel pump for pumping diesel fuel from the diesel fuel tank to the supply fuel valve, and a vegetable oil fuel pump for pumping vegetable oil fuel from the vegetable oil fuel tank to the supply fuel valve, wherein the electronic block controller is further for, in response to a user changing the fuel selector switch from diesel fuel to vegetable oil fuel after starting the diesel engine, sending control signals to turn the vegetable oil fuel pump on and the diesel fuel pump off.

4. The system of claim 3, wherein the electronic block controller is further for, in response to a user changing the fuel selector switch from vegetable oil fuel to diesel fuel prior to shutting the diesel engine off, sending control signals to turn the diesel fuel pump on and the vegetable oil fuel pump off.

5. The system of claim 4, further comprising indicator lights in communication with the electronic block controller, wherein the electronic block controller is further for, in response to a user setting the fuel selector switch to vegetable oil fuel operation, sending a signal to display an indication on the indicator lights that the fuel selector switch is set to vegetable oil fuel operation.

6. The system of claim 5, wherein the electronic block controller is further for, in response to a user setting the fuel selector switch to diesel fuel operation, sending a signal to display an indication on the indicator lights that the fuel selector switch is set to diesel fuel operation.

7. A method for using vegetable oil as fuel for a diesel engine, comprising:
in response to a user setting a fuel selector switch to diesel fuel prior to starting a diesel engine:
positioning a supply fuel valve to direct diesel fuel from a diesel fuel input port to a supply fuel output port which is in fluid communication with a fuel input port of a high pressure injection pump, the diesel fuel being received from a diesel fuel tank;
positioning an overflow fuel valve to direct overflow diesel fuel received from the high pressure injection pump to a diesel fuel output port in fluid communication with an overflow diesel fuel input port of the diesel fuel tank;
starting said diesel engine;
in response to the user changing the fuel selector switch from diesel fuel to vegetable oil fuel after starting the diesel engine:
positioning the supply fuel valve to direct vegetable oil fuel from a vegetable oil fuel input port to the supply fuel output port, the vegetable oil fuel being received from a vegetable oil fuel tank;
waiting a predetermined time to allow the vegetable oil fuel to flush the diesel fuel to the overflow fuel valve, and then positioning the overflow fuel valve to direct overflow vegetable oil fuel received from the high pressure injection pump to a vegetable oil fuel output port in fluid communication with a overflow vegetable oil fuel input port of the vegetable oil fuel tank; and
in response to the user changing the fuel selector switch from vegetable oil fuel to diesel fuel prior to shutting the diesel engine off:
positioning the supply fuel valve to direct diesel fuel from the diesel fuel input port to the supply fuel output port; and
waiting a predetermined time to allow the diesel fuel to flush the vegetable oil fuel to the overflow fuel valve, and then positioning the overflow fuel valve to direct overflow diesel fuel received from the high pressure injection pump to the diesel fuel output port and the overflow diesel fuel input port of the diesel fuel tank.

8. The method of claim 7, further comprising:
turning on a diesel fuel pump for pumping diesel fuel from the diesel fuel tank to the diesel fuel input port of the supply fuel valve in response to the user setting the fuel selector switch to diesel fuel prior to starting the diesel engine;
turning off the diesel fuel pump and turning on the vegetable oil fuel pump for pumping vegetable oil fuel from the vegetable oil fuel tank to the vegetable oil fuel input port of the supply fuel valve in response to the user changing the fuel selector switch from diesel fuel to vegetable oil fuel after starting the diesel engine; and
turning off the vegetable oil fuel pump and turning on the diesel fuel pump in response to the user changing the fuel selector switch from vegetable oil fuel to diesel fuel prior to shutting the diesel engine off.

9. The method of claim 8, further comprising:
displaying an indication on indicator lights that the fuel selector switch is set to diesel fuel operation in response to the user setting the fuel selector switch to diesel fuel prior to starting the diesel engine;
displaying an indication on indicator lights that the fuel selector switch is set to vegetable oil fuel operation in response to the user changing the fuel selector switch from diesel fuel to vegetable oil fuel after starting the diesel engine; and
displaying an indication on indicator lights that the fuel selector switch is set to diesel fuel operation in response to the user changing the fuel selector switch from vegetable oil fuel to diesel fuel prior to shutting the diesel engine off.
